(19) United States
(12) Patent Application Publication
(10) Pub. No.: US 2023/0122336 A1
(43) Pub. Date: Apr. 20, 2023

(54) The Method of Qualitative Distribution of Sugar Beet Dry Matter, Products Obtained by the Mentioned Method and Food Containing Such Product

(71) Applicant: Boris Zitný, Nitra (SK)

(72) Inventor: Boris Zitný, Nitra (SK)

(21) Appl. No.: 17/905,611

(22) PCT Filed: Sep. 2, 2020
(86) PCT No.: PCT/SK2020/050016

§ 371 Date: Sep. 2, 2022

(30) Foreign Application Priority Data
Mar. 4, 2020 (SK) PP 50013-2020

(51) Int. Cl. C13B 5/06; C13B 10/14; C13B 20/00; A23L 29/30

(52) U.S. Cl. CPC C13B 5/06; C13B 10/14; C13B 20/00; A23L 29/30

(57) ABSTRACT

A method for the qualitative distribution of sugar beet dry matter to products usable in food production, which includes the steps: (a) grinding of sugar beet material with a dry matter content of at least 85% by weight of grist, until at least 1% by weight of the grist attains a particle size of 1 μm to 1000 μm, (b) dividing the grist into fractions based on particle size and/or particle density, to create at least one fraction with a particle size below 500 μm and in the case of at least one fraction with a particle size above 500 μm, (c) or possibly subsequent subjection of the fraction with a particle size exceeding 500 μm to steps (a) and (b) until the desired quantity of the fraction with a particle size below 500 μm has been attained, preferably 1 to 20 times. The present teaching also relates to product produced in this way.

### TECHNICAL FIELD

The present teaching concerns a method of the qualitative distribution of sugar beet dry matter to products usable in the food industry in human nutrition.

### BACKGROUND

Sugar beet is used economically mainly as a raw material for the production of beet sugar. The method of the sugar production from sugar beet is known in the present state of the art and there is a well-described process that uses the extraction of sugars with water and their subsequent separation from the aqueous extract thus obtained in the framework of further processing. This process creates by-products such as sugar beet pulp, molasses and calcium sludge after carbonation of raw juice. These by-products still contain a part of sugars and, moreover, contain nutritionally important substances that are not used for human consumption and represent the losses of valuable food materials.

The extraction of sugars with water and their separation by the method used for sugar production in sugar factories leads to the loss of a significant portions of valuable substances such as minerals, phenolic compounds, betaine, amino acids, proteins, fibre, and other nutritionally important substances that occurs in the root (bulwark) of sugar beet. Only sucrose is utilized. By-products created in processing are used only in minor scale in the food industry. The classical method of obtaining crystallised sugar as food is burdened with high losses of raw material and therefore is inefficient from this point of view. The wet fractionation process resulting in the loss of important nutrients valuable in human nutrition, which according to known knowledge play an important role in sugar metabolism, e.g. fibre lowers the glycaemic index, minerals are essential for human metabolism. Moreover, wet fractionation is more economically and also technologically more demanding.

Products from the entire sugar beet root contain a whole spectrum of substances of sugar beet dry matter, including beet sugar (sucrose). Due to the high content of fibre in these preparations, their use as alternative sweeteners is limited mainly due to their limited solubility and often negative sensory properties (taste and odour of sugar beet). In those preparations where negative odours and flavour substances from sugar beet are partially eliminated, there still remains the problem of solubility of the fibre portion. As some types of foods require low viscosity, high solubility, or low light absorbance, the use of crystalline sucrose, which is obtained by the wet process, is still more advantageous in these cases. The use of crystalline sucrose (beet sugar) is nutritionally associated with health risks, in particular the risk of “non-communicable diseases” (diabetes, hypertension, cardiovascular diseases, liver and kidney disorders and obesity).

The state of the art also describes several other methods of processing whole sugar beet roots, different from that of the sugar industry. In document WO2018203856, the author describes a method of preparation of an alternative sweetener from sugar beet, which whole or divided into smaller pieces, was cooked, roasted or treated by microwave radiation; if the integrity of the sugar beet roots became disturbed before heat treatment, they were soaked in a stabilising solution of reducing agents before heat treatment and then they were dried and grounded to the desired particle size. A similar procedure is described in application EP0762835, where sugar beet was treated with hot steam or water at a temperature of 87° C. or above, subsequently it was dried with hot air at a temperature above 100° C. Document U.S. Pat. No. 5,795,398 describes the fractionation of sugars and other important sugar beet fractions using chromatographic methods of wet separation of substances.

In the state of the art, there are numerous methods for processing whole sugar beet roots in a manner other than by aqueous extraction into alternative sweeteners containing all substances from the whole sugar beet root, where the sugar beet is first stabilised against oxidative changes and reactions leading to discoloration, then treated with a change of pH, or by the addition of additives, dried and ground to the required fineness.

The methods described in the state of the art, which use a whole sugar beet root for processing and utilize more substances from content of sugar beet dry matter for food purposes, not just sucrose, are not focused on the qualitative fractionation of dried sugar beet by the dry method. However, many of them deal with the process of grinding the products obtained from whole sugar beet roots, especially with the purpose to obtaining the desired particle size. The particle size of dry powdered products is a common requirement for the food application of dry materials. Moreover, a higher content of insoluble fibre with a particle size above 30 μm can cause a feeling of sand on the tongue when consuming such products; this deficiency can be eliminated by grinding.

In the state of the art, the grinding of sugar beet is used as a final operation for use in food industry where grinding standardises the properties of the products, improves the handling of the material during its storage and simplifies its application in food production.

We found that if sugar beet with a dry matter content of 85% by weight or more is processed by the milling process, not only division of dried matter into smaller particles occurs, but also specific division of particles, substance (chemical) composition of which vary and depends on a size of new born particles in the milling process, as a consequence of forces applied on the dried matter during milling.

### SUMMARY

The essence of the present teaching is a method of qualitative distribution of sugar beet dry matter based on grinding of dried sugar beet and subsequent specific division of the obtained ground material (grist). The specific division of the ground dried material (grist) from sugar beet leads to an increase in the concentration of sugar beet constituents in specific fractions exceeding the values of the concentration of these constituents in sugar beet dry matter. In this way, the content of one or more constituents in one or a group of obtained fractions increases and at the same time the content of this substance or substances in another or other fractions decreases. The presented method uses new knowledge about the method of separating the tissues of dried sugar beet. The material from dried sugar beet with a moisture content of 15% by weight or less, preferably below 12% by weight, or even more preferably below 10% by weight, and most preferably below 8% by weight, can be ground into smaller particles, though the chemical composition of the resulting particles with a size of up to 500 μm (or from 1 μm to 500 μm) is not identical to the chemical composition of the entering material. In practice, it is beneficial to use in the grinding step a dried sugar beet material with a moisture content of less than: 1% by weight, 2% by weight, 3% by weight, 4% by weight, or possibly less than 6% by weight. During grinding, the dried sugar beet tissues are broken due to the effect of acting forces. A sugar beet root contains various types of tissues and cells, chemical composition of which also differs. After drying, different tissues of different chemical composition varied in rheological properties, therefore, when external forces are applied during grinding, tissues compensate for these forces in different ways. Due to the very different energy compensation of individual tissue types, depending on their chemical composition, the tissues break down so that relatively harder tissues form smaller particles (mono, disaccharides, low molecular weight substances), and with increasing tissue flexibility (due to the content of different types of sugar beet fibre, also with increasing humidity), larger particles always forms, while its composition changes gradually with a change in rheological properties. The different tissue components have different affinity to water and thus bind water unevenly during the drying process, which also affects the way how it is divided to fractions. In this way, different fractions of sugar beet fibre are separated with a portion of minerals, betaine and other nutrients. Their deeper redistribution is possible with repeated more intensive grinding according to the same principle. The speed and efficiency of separation depends on the intensity and type of force acting on the particles of the dried material in the grinding process, as well as on the moisture of the material, and also on the method of fractionation (separation) of particles into fractions. If during the grinding process insufficient energy is supplied, or if the moisture content of the material particles is too high, then the new born particles above 500 μm emerge, whose chemical composition is similar to the composition of the material entering the grinding process. The moisture of the material affects the rheological properties of all parts of material, which is especially important during the grinding process, where the change in the rheological properties also leads to a change in the energy compensation by particles, which affects the way the particles break down into smaller particles. Therefore, when the moisture content of the material changes before or during grinding, the fractionation interface shifts. An important condition is to achieve a moisture value of the material at which the particles do not stick together during or after grinding, because such material cannot be effectively separated by a dry fractionation method. Sufficient grinding of the dried material and the attainment of a specific particle size results in the separation of tissues where particles of different sizes have different material compositions and these are subsequently separated by a fractionation process to form fractions having different chemical compositions. In this way, the individual chemical substances are separated from the dried tissues and their transition into the fractions with a precise particle size interval, where the qualitative distribution of substances from sugar beet grist takes place by a dry method without the need of water extraction.

Moreover, by reducing the content of less polar substances, especially fats and phytosterols, from the cell walls of tissues, the rheological properties of the material, as well as the properties of the resulting particles, change significantly. Thereby, the efficiency of this method of separation and fractionation of constituents increases even more significantly (making the process more efficient). Using this method, it is possible to fractionate the dried sugar beet material into fractions having a high concentration of one or a group of substances at the lower grinding energy.

According to the present teaching, qualitative distribution means the division of the sugar beet dry matter into fractions with mutually different ratios of substance (chemical) composition.

According to the present teaching, the dried material (dry matter) of sugar beet means any material of whole sugar beet roots with a dry matter content of 85% by weight or more.

In the presented method it is also possible to produce sucrose with a purity exceeding 90% by weight, and in certain cases exceeding 95% by weight. The sucrose obtained in this manner is not extracted with water or crystallised, so this method represents a new method of obtaining beet sugar by the dry method. The beet sugar thus obtained has a better nutritional composition than the water extraction method, contains a proportion of minerals, a proportion of fibre as well as proportions of other nutritionally important substances from sugar beet, thus significantly improving the nutritional parameters of the sugar, and thereby helping to reduce health risks associated with its overuse in the food industry.

The method under the present teaching also makes it possible to control the representation of the individual components contained in the dry matter of the sugar beet in the resulting fractions, which are products for use in the production of foodstuffs.

The resulting fractions have different chemical-physical properties (water binding, solubility, colour, affinity for fats, and others) depending on their composition, which are usable in the production of different types of foodstuffs.

The method under the present teaching utilizes nutrients from whole sugar beet root, not just sucrose. At the same time, it increases the efficiency and economy of sugar beet processing for wide utilization within food manufacturing.

Sugar beet contains a range of polysaccharides (especially hemicellulose, cellulose, pectin substances) as well as simple sugars (mono- and disaccharides), where sucrose is represented to the greatest extent (up to 60%-70% in the dry matter of sugar beet), glucose and fructose, as well as minerals (especially potassium, magnesium, iron, calcium and others), as well as other nutritionally important substances such as betaine, phenolic compounds and vitamins.

The method under the present teaching processes the material of whole sugar beet root after its drying to a dry matter content of at least 85% by weight of dry matter, preferably above 88% by weight, more preferably above 90% by weight of dry matter, still more preferably above 92% by weight of dry matter, and even more preferably more than 94% by weight of dry matter. The best results are obtained if the dry matter content of the sugar beet material ranges from 96% to 100% by weight.

The method of qualitative distribution of sugar beet dry matter according to the present teaching comprises the steps of:
(a) grinding of sugar beet material with a dry matter content of at least 85% by weight to grist, until at least 1% by weight of the grist has a particle size of 1 μm to 1000 μm,
(b) dividing the grist into fractions based on particle size and/or particle density, resulting in at least one fraction with a particle size below 500 μm and possibly one fraction with a particle size above 500 μm,
(c) optionally subsequent subjecting of the fraction with a particle size exceeding 500 μm to steps (a) and (b) until the desired quantity of the fraction with a particle size below 500 μm has been attained, preferably 1 to 20 times.

An important feature of this method is the possibility of targeted influencing the chemical composition of the created fractions by the method of grinding, where the method of grinding is defined by the type and intensity of grinding. Both the type and the intensity of grinding affect the composition of the subsequently formed fractions in the same cycle.

The milling method under the present teaching means the type and intensity of the acting forces applied on the particles of the dried material during grinding.

The type of acting forces means the acting of the force on the dried material in shear and/or cut and/or in pressure and/or by sonication during extraction.

The force intensity means the magnitude of the resultant force acting per unit area of the particle or per mass of the particle, per unit time during which these forces act on the particle of the material. A measurable manifestation of the grinding intensity is the particle size achieved in the grist, where with increasing intensity the average particle size decrease and with decreasing intensity the average particle size conversely increases in the grist. The grinding intensity under industrial conditions can be set individually for each device with one or a combination of the following parameters: the power of the machine which is transferred to the grinding part of the equipment, the speed of the grinding equipment, the rigidity of the grinding equipment (where rigidity means the force and its resultant which the grinding equipment is able to develop during grinding towards the particle(s) with unit surface area, taking into account the technical and material construction of the equipment). These parameters are known to an expert in the given field and can also be determined indirectly by means of the effect achieved during the grinding of the given material.

The qualitative composition of the fractions is further influenced, in addition to the moisture content of the material during grinding, also by the method of separating the individual fractions of the grist (fractionation).

Separation of individual fractions can take place on sieves with a mesh from 10 μm to 500 μm and from 500 μm to 3000 μm. The grist is separated into fractions by particle size.

Separation of the individual fractions can also take place by fluid fractionation on the basis of the particle air drift threshold.

Separation of the grist into fractions by particle size and/or density and particle air drift resulting in increasing concentration of certain specific sugar beet constituents in the individual fractions. The particle size is also determined by its composition when the fractionation interface is reached or exceeded. It is beneficial if the grinding process on a grinding device with adjustable grinding parameters is adjusted so as to produce, in particular, particles with a size close to the fractionation interface for the given type of substance or group of substances.

The fractionation interface under the present teaching means such particle size that demonstrates the dependence of the chemical composition on particle size and/or the air drift threshold. Thus, when the fractionation interface has been reached, the composition of the fractions obtained after dividing the grist by particle size and/or density and/or air drift threshold changes compared to the input dry material before grinding. Particles larger in size than the fractionation interface generally have a similar composition to the dried material entering the process of grinding and separating the fractions.

The fractionation interface during the first grinding of the dried material with a moisture content of 0% by weight to 15% by weight, preferably from 0% by weight to 8% by weight, most preferably up to 4% by weight, is present in the particle size interval of 50 μm to 500 μm, but primarily of 50 μm to 350 μm, depending on the grinding method and the moisture content of the grist. Achieving the particle size of the fractionation interface can also be carried out in subsequent steps of grinding the same grist repeatedly, where the particle size of the grist decreases progressively in each grinding step, producing a larger proportion of smaller-size particles after each grinding step. This is particularly beneficial if the particles of dried material are too large and, during one cycle through the grinding device the splitting directly into the small particles below 500 μm is technically hard to achieve.

After grinding, a grist is obtained which is a mixture of particles of varying size, density and different particle air drift threshold. The grist is then divided into fractions according to: particle size and/or density and/or their air drift threshold. The resulting fractions mutually differ in particle sizes and/or density and/or particle air drift threshold, and therefore also in their chemical composition, resulting in different technological (physical-chemical) properties. The specific mass (density) of individual fractions of the grist with a particle size below 500 μm, depends on the size of particles in individual fractions and their composition from 400 kg·m⁻³ up to 900 kg·m⁻³. Depending on the quality of the input raw material, these threshold values may differ within the range of approximately ±100 kg·m⁻³. The grist density, or fraction density, under the present teaching means the specific mass of the given loose material obtained by weighing lose material of unit weight in a container with a unit volume, after deducting the weight of the container.

The technological properties (such as solubility, colour, water binding, etc.) of the obtained fractions are determined by their chemical composition and particle size. All fractions are products utilizable in food production.

Under the present teaching, the fractions with regard to their chemical composition are not separated strictly by this method. When comparing the chemical composition of two immediately neighbouring fractions (e.g. one obtained on a 50 μm sieve and the other on a 100 μm sieve, and between these sieves there is no other sieve), each of the fractions contains the same distribution of substances (chemical composition), but individual substances are present in different quantities. The method under the present teaching gradually increases/decreases the concentration of the substances in the individual fractions. The difference in quantities depends on the type and intensity of grinding, as well as on the moisture content of the grist.

Grinding is a process characterised by the action of external forces (mostly exerted by the grinding device) on the particles of dried material, or on the fractions of the material, as a result of which the particles are divided into several smaller particles to form a mixture of these particles, termed as a grist. Grinding can be performed by various devices, which differ in the way in which the grinding forces act on the particles during the grinding process. Grinding can be performed by devices which act on the particles by a force exerted in pressure, shear, cut, or impact on the friction surface or by sonication, or by any random combination of the listed forces during grinding or homogenisation. Under the present teaching, the grinding step can be repeated in the framework of processing, while when repeating the grinding step in the process different settings of grinding forces, aiming to change resultant of the force acting on the particles of the material during every subsequent cycle of grinding the fractions (e.g. the pressure of the grinding surfaces, the speed of the rotating grinding rollers, the roughness of the surfaces, the speed of the grinding rotor, or knife and other known methods affecting resultant of the applied forces) can be performed with every subsequent grinding.

The input sugar beet material after drying, which has not yet been ground, should preferably have a minimum particle size at the upper limit of the fractionation interface (500 μm), but preferably 1 mm or more, more preferably 2 mm or more. It is most beneficial that the material be in the form of dried particles, where the particle surface area is at least 2.0 cm² to 100 cm². The material is suitable for grinding even if the particle size is greater, where the upper limit of the material's particle size after drying is not limited.

It is beneficial for realization of grinding that natural ruptures and breakage or splitting of the dried tissues occurs by grinding larger particles of the original tissues to form a spectrum of fractions of smaller particles, the formation of which makes it possible to fractionate the matter according to the chemical composition. If the particles are ground to a grist immediately after the first grinding with all the grist particles having a similar size (they are calibrated to a certain size), their size distribution (fractionation) is not possible, or has only a little effect, over the entire range of the fractionation interface. Particle size calibration means the grinding of the material in one grinding step into a grist having approximately similar or the same particle size. The material thus ground can be fully fractionated by a fluid method, by a flowing gas.

If the input dry matter or grist has the same or very similar particle size after the grinding step, it is not possible to divide it by size of the particles (using sieves). However, it is still possible to use the fluid fractionation method. Therefore, the grist calibration to the same particle size during the grinding process is not desirable in the context of the present teaching.

The grinding of the dried material takes place in such a way that the dried material is first time ground into a grist with the creation of at least 1% by weight of particles with a size from 1 μm to 1000 μm in the grist. The first grist (designated as M1) being created after the first grinding which is a mixture of particles of different sizes. Subsequently, such grist is divided into fractions (designated as F1) by size and/or density and/or particle air drift threshold.

Division by particle size takes place on sieves with mesh sizes from 10 μm to 500 μm. For this purpose, a grid of subsequently assembled sieves is arranged, where the number of sieves in such arrangement is not limited. It is preferable to use sieves with a mesh size in the order of 500 μm, 400 μm, 200 μm, 100 μm, 50 μm, 25 μm, but the mesh size of the individual sieves in the grid can be redistributed to this extent in other ways. Subsequently, fractionation is achieved by passing the grist through the sieve system.

Fractionation by density and/or particle air drift threshold, also referred to as fluid fractionation, uses a gas flow with a flow rate from 0.01 m·s⁻¹ to 7.5 m·s⁻¹ to distribute the grist and where the particles are drifted from the space with the lowest velocity up to the space with the highest gas flow rate gradually, so that each time the gas velocity is increased, a fraction whose air drift threshold corresponds to the current gas flow rate is separated (particles are carried away in the gas flow). The process can also be used the other way round, where the grist is first divided at the highest gas flow rate with a gradually decreasing rate. It is beneficial to use a gas flow rate of 0.50 m·s⁻¹ to 4.5 m·s⁻¹ in steps, with the gradually increasing/decreasing of the gas flow by 0.20 to 1.0 m·s⁻¹ in each fractionation step. In each step, a different fraction of the grist particles is separated. With a dry matter content of 85% by weight or more, the dried material is stable to adverse oxidative changes, and therefore the use of atmospheric air as a gas for fluid fractionation of the grist is most preferable.

It is beneficial that the relative humidity of the gas be adjusted so that water vapours do not pass into the grist or fraction to increase its moisture content above 15% by weight. In such a case, the grist becomes difficult to separate and the efficiency of the fractionation process decrease significantly.

It is preferable if the steps of sieve separation and fluid fractionation are alternated or take place simultaneously. By this way, the improving the distinction between the particles by their quality and, as a rule, also speeding up the fraction separation step is achieved.

Due to the setting of the dividing parameters, which are the size of the mesh openings of sieves and/or the air flow rate, after the first grinding, individual fractions in the range from 1 to 3500 μm, preferably five to six fractions in the range from 1 to 500 μm and one to two fractions exceeding 500 μm, are created. Fractions below 500 μm can be used directly as products for food-industry utilization, or, can be repeatedly ground and fractionated in the next process cycle.

For the purposes of the present teaching, the process cycle is a sequence of grinding steps followed by separation to form fractions.

Individual fractions with a size below 500 μm are characterised by a varied chemical composition and distinct properties. Fractions above 500 μm have a similar and more equalized chemical composition, and their division results in a particle distribution rather only on the basis of particle size where the differences in the chemical composition of the fractions are small.

Properties of the fractions mean physical and chemical properties, in particular properties such as water binding, solubility and colour. In general, there is an interdependence where with the increasing particle size the solubility decreases, the water binding increases, and the colour hue darkens. The content of off-taste substances and aromatic substances originating from sugar beet is significantly reduced in the fractions obtained below 100 μm or eventually below 150 μm.

Particles larger than 500 μm obtained after the first cycle are repeatedly ground to form a second grist (designated as M2) and repeatedly fractionated (D2). The principle is the same as in the first cycle. Fractions (F2) are formed again while their composition and properties are similar to the composition and properties of fractions below 500 μm obtained after the first cycle (F1). Characteristic for the composition of F2 fraction is that the fractions below 100 μm contain less mono- and di-saccharides compared to the same F1 fraction, where the difference is at a level of 2% by weight to 8% by weight depending on the sugar content in the dry matter of the input raw material, moisture content of the dried material during grinding and the grinding method. The F2 fractionation process repeatedly creates particles of a fraction having a size of 1 μm to 500 μm that may be used as products, and a fraction above 500 μm, which is repeatedly ground to form a grist (M3) and divided into fractions (F3). This process in cycles is repeated until the desired dry matter proportion with a particle size below 500 μm is attained, or, until the desired fraction composition is obtained after distribution by size and/or density and/or particle air drift threshold. With each subsequent cycle of grinding and fractionation (Fx) above 500 μm, the proportion of sugars in the fraction below 100 μm or below 150 μm from fraction Fx usually slightly decreases compared to the same fraction from the previous fractionation (Fx₋₁). The splitting into fractions depends on the method of grinding and on the qualitative composition of the input raw material (dried sugar beet).

The following dependencies have been found in the implementation of this method. The distribution of substances after grinding depends on the moisture content of the material. As the moisture content of the material increases, the proportion share of fractions obtained below 200 μm decreases and the proportion share of fractions with higher particle size increases. As the moisture content of the material increases before grinding, the differences in the chemical composition of the particles between the individual fractions obtained decrease. It is preferable that the moisture content of the dried material is as low as possible, optimally below 90% by weight. The grinding method plays an important role in obtaining the quantity and quality of the individual fractions. With increasing grinding intensity, the fraction(s) below 100 μm increase. In terms of the type of grinding, every such type of grinding of the dried material is suitable, where the particles of the dried material are stressed by pressure and/or by shear and/or by cut, by a force that causes the grist particles to break or split into smaller particles, during the grinding process, is suitable. Methods of achieving the required force during the grinding process on technical equipment, as well as settings and geometry of grinding equipment, utilizing of individual types of grinding and their combinations, are structurally and technically known in the state of the art.

Preferably, the grinding is performed on grinding rollers, with a narrow gap, co-called the grinding gap, is located between the two rollers that is adjustable and defines the maximum particle size of the resulting grist. The surface of the rollers during the first grinding is preferably grooved, which increases the proportion of cut forces during grinding. The proportion of shear forces during grinding increases by the rotational speed advance of one of the rollers while the circumferential speed of the second roller is lower. Rollers with a smooth surface can also be used, where the effect of the compressive force on the particles of the dried material is increased. The combination of several pairs of grinding rollers with different settings of speed, speed ratios of rollers, size of the grinding gap, and with different surface design, increases or decreases the intensity of grinding, and the type of grinding. The changes in grinding process affects the proportion shares of individual fractions formed and their quality each time the material passes through the grinding equipment.

Another advantageous solution is grinding by means of mixer blades in an enclosed space, where larger particles over 2 mm are chopped with blades at the beginning of grinding and immediately broken by impacts against the inner surface of the grinding device and also by impacts of particles against each other in the grinding space. The process resulting in a diverse grist which composition of particles by size depends mainly on the time of action of the grinding forces (duration of grinding). It is also possible to use other construction types of grinding equipment. With different types of grinding, the division of the individual fractions from the dried material differs by weight, but the chemical composition of the individual fractions is similar with minimal differences.

The preferable range of moisture content of the dried material before grinding, with regards to the fractionation of the material into fractions with different substance composition, is from 0% by weight to 12% by weight, preferably from 0% weight to 8% by weight, even more preferably from 0% by weight to 6% by weight.

After the first grinding of the dried material with a moisture content below 12% by weight, particles below 100 μm contain more mono- and disaccharides, especially sucrose, but less soluble fibre than larger particles above 100 μm or above 150 μm. Even after the first grinding, smaller fractions below 100 μm are enriched with sugars, resulting in fractions from 100 μm or from 150 μm to 400 μm, which contain more fibre compared to fractions below 100 μm. Fractions above 450 μm, mostly above 500 μm, contain a mixture of sugars and fibre, the ratio of which is close to the ratio in which they occur in the dried material of sugar beet before grinding. In fractions above 350 μm or above 400 μm, the tissues are not sufficiently disrupted by grinding force, thereby the tissues are not enough separated into particles with different chemical composition (substance composition).

The distribution of substances into individual fractions according to substance composition is always influenced by the composition of the input raw material. In the root of sugar beet, the individual constituents (individual sugars, minerals, types of fibre, etc.) are not equally distributed in the whole volume, the distribution of individual substances in the root is uneven. Therefore, by dividing the grist into fractions in repeated experiments in this way, a high variability of the substance composition is achieved within the individual fractions obtained by division by particle size and/or particle air drift threshold and/or density. The same trends in the distribution of the substance composition apply to each repeated fractionation of the equally obtained grist into fractions, but the fractionation interface may vary. The highest fibre content after the first grinding is generally in the fraction in range of particle size from 100 μm to 250 μm. As the particle size increases, the fibre content decreases, but the lowest fibre content is found in the fractions below 150 μm, or below 100 μm, or even below 80 μm. Tissues with a higher content of mono- and disaccharides in dry form are more prone to transition to smaller fractions during grinding under the same grinding intensity. The fibre is concentrated in the fraction above 80 μm, or above 100 μm up to 200 μm, or up to 250 μm. Fractions above 200 μm or above 250 μm to 400 μm up to 500 μm contain pieces of tissues in the mixture where mono- and disaccharides, minerals, fibre and other constituents remain trapped in the fragments of tissues that were not sufficiently disturbed during grinding, resulting into a similar composition to that of the dried material, but not the same. Particles above 500 μm have almost identical composition as the input dried material. Each of these fractions has different chemical and physical properties.

By repeating the grinding and fractionation step with the material fractions up to 500 μm, formed in the previous grinding and fractionation cycles, it is possible to gradually increase the differences in the chemical composition of the individual fractions. By targeted selection of fractions and by repeating cycles of grinding and fractionation of only certain fractions with a high content of one or a group of substances, one substance or a group of substances with the desired properties is concentrated. The number of repetitions of grinding and fractionation cycles is not limited. It is preferable that the number of grinding and fractionation cycles be repeated 1 to 20 times.

It is beneficial if the input dry matter is not degraded. This means that the sugar beet is processed to dry matter in a way that prevents reactions which reduce the food-processing quality of the dried material and thus products, which is generally reflected by the colouring of the dried sugar beet material in shades of dark to black. In general, we define these changes as degradation. Degradation impairs the quality of sugar beet products and reduces their usability.

Furthermore, we have found that the process of grinding and fractionation of the dried material is significantly affected by the content of fats and/or phytosterols in dry matter entering the process and also in the grist. The chemical composition of the fractions and the fractionation gradient change with the decreasing content of fats and phytosterols in the material entering the grinding and/or fractionation step. When grinding the dried material, or a fraction in which the content of fats and/or phytosterols is reduced compared to their content in the sugar beet dry matter, the fractionation gradient increases in one cycle of the process.

The fractionation gradient is a parameter that characterises the average difference in the concentration of a given substance between two fractions during fractionation in one process cycle. Increasing/decreasing the fractionation gradient means that the difference in the representation of one specific substance in the substance composition of the two fractions is higher/lower compared to another state of the process. It is advantageous to use the fractionation gradient as a comparison parameter of the two process states in the transfer of substance A to fractions under different conditions. For example, the difference in sucrose content between the fractions obtained on sieves with a sieve mesh size of 50 μm and 100 μm in the case of grist from the dried sugar beet material without reducing the fat and phytosterol content may range from 2% to 20% by weight, in favour of a smaller fraction. However, under the same process conditions, in the same case where the dried material is free of the major share of fats and phytosterols before grinding, the difference in sucrose content between the fractions is 4% to 32% by weight. In this example, the fractionation gradient for sucrose, for fractions with and without the fat and phytosterol extraction step is higher on average by 7% by weight, in favour of fractionation of dried material free of fats and phytosterols.

The higher the fat and/or phytosterol content is in the material prior to grinding and fractionation, the smaller the differences are in the substance composition of the individual fractions obtained. The extraction of fats and/or phytosterols causes changes in the rheological properties of the dried tissues in the dried material, leading to their unequal division when exposed to forces acting during the grinding step compared to the material in which the fat and phytosterol content has not been adjusted.

It is therefore advantageous to reduce the fat and/or phytosterol content in the input dry matter (or also in the fractions from the individual cycles) by mixing the dry matter/fraction with solutions of organic substances from the group of monohydroxy alcohols containing one to four carbon atoms in the molecule (methanol, ethanol, propanol, butanol), or with acetone or another organic solvent or a mixture of organic solvents or supercritical carbon dioxide, where the solution of organic substance or supercritical carbon dioxide must be of the same or lower chemical polarity (of the same or lower dielectric constant) as the ethanol solution with water with an ethanol concentration of 50% by volume at 20° C. By mixing organic solvents, or supercritical carbon dioxide, with the dried material or sugar beet fraction, in a ratio ranging from 2:1 to 1:10 (material:organic solvent), where the concentration of organic substance in the mixture with sugar beet material is at least 50% by volume in the liquid phase of this mixture. In this way, the extraction of fats and/or phytosterols is carried out together with other less polar substances from the dried material or the sugar beet fraction. The process is carried out at temperatures at which the organic solvent is in liquid or gaseous form. The most preferable for industrial extraction is the use of ethanol. The mixture of dried material or fraction with organic solvent is then separated in the extraction process to form a liquid and a solid phase. The separation can be performed by separation by filtration or centrifugation in a manner known in the state of technology. Both the liquid and the solid phase are subsequently dried at temperatures from 20° C. to 160° C., at atmospheric pressure or vacuum. It is preferable to capture solvent vapours during the drying process of both phases and regenerate the liquid solvent for further use in the process. The process for regenerating the organic solvent can be carried out by distillation or another method known in the state of the art. The solid phase creates a material with a reduced content of fats and/or phytosterols, where the final concentration of fats and phytosterols depends on the solvent and the temperature used. It is advantageous that the final concentration of fats and phytosterols in the dried material or fraction before the grinding and fractionation cycle is as low as possible, preferably below 0.15% by weight, or even more preferably below 0.09% by weight.

Depending on the solvent used, the liquid phase after drying contains a mixture of fats and phytosterols with other sugar beet constituents. This extract also contains vitamins and phenolic substances with antioxidant properties. We have found that the amount of valuable phenolic substances in the extract is higher if the input dry matter is not damaged by degradation.

The step of extracting the dried material or fraction from sugar beet is a step that concurrently improves the sensory properties of the products (taste, aroma), but also the nutritional and overall sensory properties of the sugar beet material. We have further found that by repeating the grinding and fractionation after the fat and/or phytosterol extraction step, the particles are divided differently by their substance composition in the separation step so that after the extraction the grist contains a substance composition of the material fraction below 100 μm or below 150 μm with significantly greater representation of mono- and disaccharides compared to the composition of the same fractions obtained by fractionation of equally moist, ground and fractionated material prior to the extraction. The fractionation gradient in the case of mono- and disaccharides in favour of the extracted material is at the level of 2% to 48% depending on the size of the compared fraction. When comparing the fractionation of extracted materials with reduced fat and phytosterol content and materials where the content of these substances was not reduced, an important difference was also noted in the shift of the fractionation interface, where the fractionation interface is shifted upwards by approximately 50 μm to 150 μm. The difference in the fractionation gradient when comparing the fraction from extracted starting raw materials with unextracted ones, under the same process conditions and the same starting dried material, can also be observed for other important sugar beet constituents, such as minerals or betaine, where the fractionation gradient is different (fractionation gradient for minerals is from 2% to 34%). There is also a different distribution of individual types of minerals into individual fractions, where for example the calcium content grew with decreasing particle size in individual fractions, but the potassium content conversely grew with increasing particle size of individual fractions (e.g. in a fraction of 50 μm and lower, a calcium content was 1260 mg/kg and potassium content was 6780 mg/kg, but in a fraction of 400 μm to 450 μm the calcium content was 980 mg/kg and potassium content was 7660 mg/kg).

In order to reduce the content of non-polar substances, in particular fats and/or phytosterols, the sugar beet material can be, prior to step (a), or between steps (a) and (b), or after the step (b), processed in the following manner:
(i) mixing of the material, grist or fraction with an organic substance, or a mixture of organic substances, whose chemical polarity (dielectric constant) is equal to or lower than the chemical polarity of the solution of ethanol and water, with a concentration of 50% by volume at a temperature of 20° C. Preferably, the material is mixed with the organic substance in a ratio of 2:1 to 1:10, at temperatures at which the used organic solvent (organic substance) or the mixture of organic substances is in the liquid state or in the gaseous state. The following steps are applied:

(ii) stirring of the mixture for the period of 0 minute up to 600 minutes, where with the increasing mixing time and temperature there is a better transfer of fats and phytosterols as well as fewer polar substances into the liquid phase of the mixture. This changes the rheological properties of the product thus treated after the separation of phases and drying of the solid phase.
(iii) separation of the mixture to a liquid and solid phase,
(iv) separate drying of the liquid and solid phases to form a product with a dry matter content of at least 85% by weight or more, preferably with a dry matter content exceeding 94% by weight, 96% by weight, 98% by weight, possibly exceeding 99% by weight.

Subsequently, the solid phase with reduced fat and/or phytosterol content can be subjected to step (i) and/or (ii) repeatedly 1 to 20 times on any fraction obtained. In this way, the properties of the fractions and/or products thus treated are selectively changed, which makes it possible to obtain new products of different substance composition during their further grinding and fractionation.

The resultant liquid phase, whose chemical polarity after separation in step (iii) is equal to or lower than the solution of ethanol and water with a concentration of 50% by volume, can be reused in step (i), to reduce the content of non-polar substances, where it is used as an organic substance for mixing with another material (grist or fraction) in which the content of non-polar substances has not yet been modified according to the present teaching.

Under the present teaching, a non-polar substance is considered to be any substance whose chemical polarity expressed by a dielectric constant is equal to or lower than the chemical polarity of a mixture of water and ethanol with a concentration of 50% by volume.

The resulting vapours of organic substances can be captured, regenerated, and concentrated for further use during the drying of the solid and/or liquid phases.

The organic solvent in step (i) may be, for example, a solution of ethanol and water or ethanol.

The subject of the present teaching is also a product produced by the above-mentioned production method, which in dry matter contains more than 80% by weight of monosaccharides and/or disaccharides from sugar beet, as well as a product produced by the above-mentioned production method, which in dry matter contains more than 30% by weight of fibre from sugar beet in the representation of mainly pectins, hemicelluloses, celluloses and their subunits.

The subject of the present teaching is also a product with a reduced content of non-polar substances produced by drying the liquid phase after separation, which in the dry matter contains at least 0.50% by weight of phenolic compounds with antioxidant activity and at least 1.0% of fats and/or phytosterols from sugar beet.

The product may also contain a combination of two or more fractions.

The subject of the present teaching also relates to a foodstuff containing a product under the present teaching.

### EXAMPLES OF EMBODIMENTS

### Example 1

Dried sugar beet with a moisture content of 1.5% by weight was ground on a homogenising mill. The particles of the dried material were in the form of slices with a cross section of 3.0×4.0 mm and a length of 30 to 120 mm. This material was ground in a manner where the blades of the homogenising mill cut and later collided with the particles of dried material at a speed of 3500 rpm. Grinding took 3 minutes in a closed container (period of holding the material in the grinding space) and created the grist. The grist was then fractionated on a system of sieves ranked in the order with a mesh size of 500 μm, 400 μm, 200 μm, 100 μm and 50 μm. The grist was brought to the top sieve with mesh size of 500 μm and sieved through sieves which moved in a circular oscillating motion. The fractionation time on the sieves was 30 minutes. After this time, the sieves produced individual fractions. An overview of the parameters and quantities of fractions obtained after the first grinding of the dried material is given in Table 1.

TABLE 1
Overview of parameters after the first
fractionation of the dried material

| | | | Relative share of |
|---|---|---|---|
| | | Mono- and | minerals content |
| | Percentage of | disaccharide | in fraction to |
| | grist fraction | content | their content |
| Faction | (average) | (% by weight) | in grist in 1 g |
| above 500 μm | 24% | 66 | 96% |
| above 400 μm | 10.5% | 64 | 90% |
| above 200 μm | 26% | 59 | 86% |
| above 100 μm | 5% | 62 | 84% |
| above 50 μm | 31% | 78 | 82% |
| below 50 μm | 4% | 84 | 79% |

The fibre content in the individual fractions was negatively correlated with the content of mono- and disaccharides, where the fractions with a high content of mono- and disaccharides contained less fibre (fibre represented mainly by cellulose, hemicellulose, pectin substances and their subunits) and vice versa. The content of total fibre in the fraction above 50 μm was about 15.5% by weight. The individual fractions had different properties. The colour of the finer fractions was paler, the water binding was highest in the fraction above 400 μm, the water solubility was the best in the fraction below 50 μm.

### Example 2

As in Example 1, the dried sugar beet material was processed into fractions. After obtaining the fractions, the fraction of a size of 50 μm, 200 μm, 400 μm and 500 μm were reprocessed by a grinding and fractionation step. Grinding was performed on rollers with the grinding gap set at 450 μm where the rollers had a grooved surface. The second fraction were thus formed from each fraction all the smaller fractions designated as fractions F2 (in total 17 fractions). The F2 fractions again had a different composition, the sugar content (mono- and disaccharides) was lower in the case of the obtained F2 fractions than that in the fraction from the first fractionation F1. Fractions F2 above 400 μm and 500 μm had a comparable sugar content with the same fractions F1. The properties of the obtained fractions were in principle similar to the properties of fractions F1, but the colour of the whole spectrum of the fraction F2 was a shade darker than the same fractions F1, the water binding was higher by 4% to 12%. These trends were observed with deviations even when the grinding setting was changed, where fractions were obtained at a higher grinding intensity, when the roller pressure during grinding was higher and the roller gap was only below 100 μm. Under such settings, fractions F2 were formed from the fraction F1, which had a more balanced sugar content in the entire size spectrum. The grist M2 obtained from the fraction after the first fractionation was alternatively ground under the same conditions on a set of smooth rollers. It was found that when smooth rollers were used, fractions below 100 μm contained a higher proportion of monosaccharides and disaccharides than equally obtained fractions ground on grooved rollers, with fractions from 100 μm to 400 μm containing more fibre (in this case, the fibre increase was highest in the fraction from 100 μm to 250 μm).

### Example 3

As in Example 1, the dried sugar beet was ground and fractionated, with the difference that the fractionation was done using the fluid method. After grinding into particles with a size of up to 1000 μm, the grist was fractionated so that it was transferred over to an 800 μm sieve, falling through the sieve and under the sieve the grist was mixed with air flow of a rate of 4.0 m·s⁻¹, whose intensity decreased down to 0.1 m·s⁻¹ at the end of the fluid tunnel. In this way, fractions F1 were obtained in a fluid method, the composition and quantitative distribution of which differed significantly from the fractions F1 obtained in Examples 1 and 2. The quantitative distribution of the fractions (yield of individual fractions) was significantly different, with an increase in fractions below 100 μm and a decrease in fractions above 400 μm. The content of mono- and disaccharides in fractions below 100 μm was on average slightly higher. Fractions from 100 μm to 400 μm contained more fibre (28% to 38%) but proportionally less mono- and disaccharides. The properties of the individual fractions were similar to the properties of the fraction F1 in Example 1, except for the properties of the fraction of 100 μm to 400 μm, and for which a significant increase in water binding was observed.

### Example 4

As in Example 1, the light white-green dried sugar beet was divided into fractions. All fractions were then separately extracted with ethanol at a temperature of 35° C. for 10 minutes under constant stirring so that each of the fractions was mixed with ethanol at a concentration of 90% by volume in a ratio of 1:1, and in a parallel experiment in a ratio of 1:2 (material:ethanol). Subsequently, the mixture was separated at the filtration interface into liquid and solid phases. The solid phase was dried in a fluid bed drier to a dry matter content of 98% by weight. The liquid phase was distilled to form ethanol with a concentration of 90% by volume, with the creation of a distillation residue. Subsequently, the material of the distillation residue was heated to 115° C. for 30 minutes, thus significantly reducing the proportion of negative odours in the material. The material from the distillation residue contained a total of 3.5% of phytosterols and 1.2% of phenolics.

Following its drying (moisture content below 2.5% by weight), the solid phase from each of the fractions was repeatedly ground using a homogenising mill and fractionated on the sieves with the same arrangement and interface as in Example 1. This created fractions where significantly more material passed to the fraction below 400 μm, most to the fraction below 50 μm and above 50 μm, which together represented more than 40% by weight the proportion from the input material with a significant increase in the content of mono- and disaccharides from sugar beet, but with a decrease in the total content of minerals in comparison with the same fractions obtained without treatment with ethanol. The fraction below 50 μm contained, after repeated grinding and fractionation F2, up to 96% weight of mono- and disaccharides, especially sucrose, which is a high-purity sucrose with a minor content of total minerals and water-insoluble fibre from sugar beet. Conversely, fractions above 100 μm to 200 μm contained a high proportion of fibre, with a decrease in the content of mono- and disaccharides to a level between 50% by weight up to 58% by weight with an increase in minerals after fractionation F3. The smallest fractionation gradient occurred when comparing fractions above 400 μm (with and without ethanol treatment). The colour of the fractions was lighter, light beige, and the sensory properties of the fractions treated with ethanol were significantly better. Subsequently, fractions above 400 μm were selectively ground, similarly giving rise to a whole spectrum of fractions. Grinding was performed on smooth rollers. The material ground in this manner was fractionated on sieves in combination with fluid fractionation at an air flow rate of 0.5 m·s⁻¹ to 6.5 m·s⁻¹, in steps of 0.55 m·s⁻¹. Six fractions were obtained. At the end of the repeated separation, it was possible in this way to separate the fractions with a high sucrose content exceeding 90% and the fractions with a high fibre content from 35% to 70% by weight in dry matter. These products were suitable for use in foodstuffs without introducing negative odours from sugar beet into the foods, while in addition to sugar they also contained a high content of other nutritionally important substances from sugar beet. Specialised properties were achieved by mixing the individual fractions based on a combination of the properties of the individual fractions and their parameters for use in the production of certain types of foods. For use in the production of jams, fractions with a size below 100 μm were used instead of sugar and fractions with a fibre content above 40% by weight with granulation above 200 μm as a gelling component with higher water binding property. Fraction F3 was used for the production of bakery products, obtained on sieves ranging from 100 μm to 200 μm, with a total fibre content of more than 45% by weight, which significantly improved the shelf life and texture of the bakery products.

In repeated experiments, the same fractionation trends were obtained, but the numerical values of the fractionation interface, the fractionation gradient, as well as the substance composition of the fractions were different depending on the quality of the input raw material and the moisture parameters of the raw material.

### INDUSTRIAL APPLICABILITY

The method under the present teaching is suitable for the preparation of sugar beet materials for use in the production of food and nutritional supplements. In this way, it is possible to divide the dried material of sugar beet into fractions rich in caloric sugars (sucrose, glucose, fructose) and minerals, as well as into fractions rich in soluble fibre containing as a major part pectin, hemicellulose containing minerals, and into water-insoluble fibre containing cellulose as its major part. Concurrently, by applying the preferable method it is possible to obtain a concentrated proportion of substances containing phenol in the molecule together with fats and phytosterols, as a separate extract. All fractions produced under the above-mentioned method retain a high portion of nutrients originating from sugar beet. This method is energy-efficient and, when applying the preferable methods of the method, it provides individual fractions with high sensory quality, in light colours in shades of white to beige that is fully free of negative tastes and odours of sugar beet.

The individual fractions are applicable as ingredients in food production or as alternative sweeteners or fortifiers and nutritional supplements.

1. A method for the qualitative distribution of sugar beet dry matter onto the products usable in food production, comprising:
(a) grinding of sugar beet material with a dry matter content of at least 85% by weight onto the grist, until at least 1% by weight of the grist has a particle size of 1 μm to 1000 μm, as measured on sieves,
(b) dividing the grist into fractions based on particle size and/or particle density, resulting in at least one fraction having a particle size up to 500 μm,
(c) optionally subsequent submission of the fraction having a particle size above 500 μm to (a) and (b) until the desired quantity of the fraction having a particle size up to 500 μm has been achieved.

2. The method according to claim 1, wherein the fractions having a particle size of up to 500 μm are: fractions with a particle size up to 250 μm.

3. The method according to claim 1, wherein the grinding is carried out by applying forces acting on the particles of the dried sugar beet material in shear and/or in skid, and/or in pressure and/or by sonication during extraction in liquid.

4. The method according to claim 1, wherein the material/grist is ground by two or more rollers and/or surfaces, between which there is a grinding gap for the grist to fall through, and/or by the collision of the grinding parts with the sugar beet material, where the grinding part can be a sharp or blunt edge or a surface.

5. The method according to claim 1, wherein in the first cycle the material is ground between the grooved rollers and/or smooth-surfaced rollers, and in the second cycle the fraction is ground on the smooth-surfaced rollers.

6. The method according to claim 1, wherein (b) is performed on sieves with mesh openings from 1000 μm to 25 μm, and/or (b) is performed by fluid fractionation according to the particle air drift threshold, at a gas flow rate of 0.01 m·s⁻¹ to 7.5 m·s⁻¹.

7. The method according to claim 6, wherein gas flow rates in the fluid fractionation are: 0.2 m·s⁻¹, 0.7 m·s⁻¹, 1.2 m·s⁻¹, 1.8 m·s⁻¹, 2.5 m·s⁻¹, 3.5 m·s⁻¹, 4.8 m·s⁻¹ to 7.5 m·s⁻¹.

8. The method according to claim 1, wherein a gas used in the fluid fractionation process is atmospheric air.

9. The method according to claim 1, wherein the fraction having a particle size up to 500 μm is subjected to (a) and/or (b).

10. The method according to claim 1, wherein in order to reduce the content of non-polar substances, in particular fats and/or phytosterols, the sugar beet material is, before (a), or between (a) and (b), or after (b), processed in the following manner:
(i) mixing of the material, grist or fraction with an organic substance, or a mixture of organic substances, the chemical polarity of which is equal to or lower than the chemical polarity of the solution of ethanol and water having concentration of 50% by volume at a temperature of 20° C., in a ratio of 2:1 to 1:10, at temperatures at which the used organic solvent or a mixture of organic substances are in liquid or gaseous state,
(ii) mixing of the mixture for a period of 0 to 600 minutes,
(iii) separation of the mixture to a liquid and solid phase,
(iv) separate drying of the liquid and solid phases to form a product having a dry matter content of at least 85% by weight or more.

11. The method according to claim 10, wherein the solid phase with reduced fat and/or phytosterol content is submitted to (a) and/or (b), and where (a) and/or (b) is repeated 1 to 20 times on any obtained fraction.

12. The method according to claim 10, wherein the created organic vapours are captured, regenerated, and concentrated for further use during the drying of the solid and/or liquid phase.

13. The method according to claim 10, wherein the organic solvent is a solution of ethanol and water or ethanol.

14. The method according to claim 1, wherein the material, gist, or fraction prior to, during or after the method has a dry matter content of 85% by weight or more.

15. The method according to any one of claim 1, wherein the volumetric mass of the grist's fractions obtained from the sugar beet grist in (b) is from 400 kg·m⁻³ to 900 kg·m⁻³.

16. A product produced by the method according to claim 1, which contains in dry matter more than 80% weight of monosaccharides and/or disaccharides from sugar beet.

17. A product produced by the method according to claim 1, which contains in dry matter a total of more than 30% by weight of fibre, especially in the representation of pectins, hemicelluloses, celluloses and their subunits from sugar beet.

18. A product produced by the method according to claim 10, produced by drying the liquid phase after separation, which contains in the dry matter at least 0.50% by weight of phenolic compounds with antioxidant activity and at least 1.0% of fats and/or phytosterols from sugar beet.

19. A product produced by the method under claim 1, which comprises a combination of two or more fractions.

20. A food containing the product according to claim 16.
